(19) United States
(12) Patent Application Publication
(10) Pub. No.: US 2003/0216907 A1
(43) Pub. Date: Nov. 20, 2003

(54) Enhancing the aural perception of speech

(75) Inventor: John D. Thomas, Gilbert, AZ (US)

Correspondence Address: Paul F. Wille, 6407 East Clinton St., Scottsdale, AZ, 85254, US

(73) Assignee: Acoustic Technologies, Inc.

(21) Appl. No.: 10/145,315

(22) Filed: May 14, 2002

(51) Int. Cl. G10L 19/00

(52) U.S. Cl. 704/200.1

(57) ABSTRACT

An electrical signal representing speech is filtered by attenuating low frequency components of the signal. The RMS amplitude of the signal after filtering is compared with the RMS amplitude of the signal before filtering and the ratio is used to control the gain of an amplifier coupled to the filtered signal. The harmonic content of the electrical signal is increased, before or after filtering, by raising the signal to a power, filtering, raising the signal to the inverse power, and filtering. The power is preferably greater than one and less than two. The final output signal is approximately as loud as the original signal.

### BACKGROUND OF THE INVENTION

This invention relates to processing speech electronically and, in particular, to a circuit for enhancing the aural perception of electronically reproduced speech. In some contexts, this is referred to as improving the intelligibility of speech.

It has been long known in the art that most of the energy of speech is located at frequencies below 500 Hz but it is the portion above 500 Hz that contains more of the distinctive sounds in speech. Recognizing this, a variety of circuits have been proposed for increasing the energy content of the higher frequencies. In general, these circuits increase the harmonic content or harmonic distortion of the signal representing speech. It is an oddity of human hearing that a slight increase in harmonic distortion improves the aural perception of speech even though the overall quality of the sound is degraded slightly.

In the prior art, there is an unrelated area of technology in which an electrical signal representing sound is deliberately distorted; viz. amplifiers for electric guitars. An electric guitar can have either a solid body or a hollow body, the latter generally being referred to as an electro-acoustic guitar. Both types of guitars include a transducer for converting the vibration of the strings to an electrical signal. An amplifier for an electric guitar has low fidelity and the low fidelity contributes to the “voice” of the guitar to such an extent that the guitar and the amplifier together are the instrument, not the guitar alone. The unique sound or voice associated with a particular electric guitar comes from several sources including the tone control circuit, a circuit for imitating an overdriven tube-type amplifier, “effects” circuits, and the audio characteristics of the speaker element and the enclosure. This invention concerns a circuit for improving the perception of speech, not a guitar amplifier, which can significantly degrade the perception of speech.

In general, the prior art discloses using filtering and then clipping to increase the harmonic content of speech signals. U.S. Pat. No. 3,292,116 (Walker et al.) describes a system using pre-emphasis (filtering) and clipping for increasing the energy content of the higher frequencies in speech. It is known to process speech signals using a clipper and a filter in either order; e.g. “A Clipper/Filter for C. W. or Phone”, The Radio Amateur's Handbook, 1958, pages 135-136.

Additional prior art includes U.S. Pat. No. 3,828,133 (Ishigami et al.), which discloses dividing the speech signal between two paths, one of which increases the harmonic content of the signal and the other simply amplifies the signal. The paths are combined to produce an output signal. U.S. Pat. No. 4,266,094 (Abend) discloses clipping, low pass filtering, and further clipping for increasing the harmonic content of speech signals. U.S. Pat. No. 4,454,609 (Kates) discloses dividing the speech signal into sub-bands and increasing the amplitude of higher frequency components in proportion to their amplitude. U.S. Pat. No. 4,887,299 (Cummins et al.) discloses a system for digital filtering, pre-emphasis, and non-linear amplifying to match the hearing of a person whose hearing is impaired. U.S. Pat. No. 5,133,013 (Munday) discloses making a Fast Fourier Transform (FFT) of the speech signal, processing the signal non-linearly, and performing an inverse transform on the data to create an output signal. In an alternative embodiment, the speech signal is divided into bands for processing. U.S. Pat. No. 5,530,768 (Yoshizumi) discloses dividing a speech signal between two paths. A first path includes a rectifier coupled to two circuits having different time constants. The outputs of the two circuits are divided and the ratio is coupled to a multiplier, which passes the original signal from the second path when the output from the circuit with the longer time constant is zero. U.S. Pat. No. 6,023,513 (Case) discloses adding even harmonics to a speech signal. U.S. Pat. No. 6,335,974 (Case) discloses cascading generators of even harmonics.

In general, analog systems are simply inadequate. In modern telephones, hearing aids, and many other applications, speech is digitized as virtually the first step in any operation. Making a digital version of an analog circuit gains little or nothing. The more recent prior art is complex, is relatively expensive for the amount of performance obtained, modifies the power of the signal, requires a large number of instructions to be executed in a short time, and often suffers from “algorithm latency.”

Algorithm latency is the result of the number of samples required by an algorithm in order to process speech. Cellular telephones quantize or digitize speech and bundle it into packets 39 milliseconds in length, or shorter, regardless of sample rate. The 39 millisecond limit is imposed by regulation, not technology. Thus, any processing of the signal must wait at least 39 milliseconds before starting. Similarly with many known algorithms for improving speech perception, an entire group of samples must be present for processing.

Changing the power level of a signal is annoying for a listener, particularly for users of hearing aids. The change in amplitude relates to frequency content, not the emphasis of the person speaking. The result is speech that sounds artificial. It is known to adjust power to a standard level during tests of filter parameters; see “Intelligibility Enhancement through Spectral Weighting”, Thomas et al., Proceedings of the 1972 IEEE Conference on Speech Communications and Processing, pp. 360-363. Even if done automatically, constantly adjusting filter parameters is undesirable because the changes would be perceptible.

In view of the foregoing, it is therefore an object of the invention to provide a circuit for improving the perception of speech in which the power level of the output signal is imperceptibly adjusted according to the harmonic and wideband content of the input signal.

Another object of the invention is to provide a speech enhancing circuit that has no algorithm latency.

A further object of the invention is to provide a relatively simple circuit for improving the perception of speech.

Another object of the invention is to provide a circuit for improving the perception of speech that is less expensive and more effective than circuits of the prior art.

### SUMMARY OF THE INVENTION

The foregoing objects are achieved in this invention in which an electrical signal representing speech is filtered by uniformly attenuating low frequency components of the signal. The RMS amplitude of the signal after filtering is compared with the RMS amplitude of the signal before filtering and the ratio is used to control the gain of an amplifier coupled to the filtered signal. The harmonic content of the electrical signal is increased, before or after filtering, by exponentially increasing the signal, filtering, exponentially reducing the signal, and filtering. The exponent is preferably greater than one and less than two. The final output signal has approximately the same amplitude as the original signal.

### BRIEF DESCRIPTION OF THE DRAWINGS

A more complete understanding of the invention can be obtained by considering the following detailed description in conjunction with the accompanying drawings, in which:

FIG. 1 is a block diagram of a circuit constructed in accordance with a preferred embodiment of the invention;

FIG. 2 is a block diagram of a circuit constructed in accordance with another aspect of the invention for producing odd harmonics of an input signal; and

FIG. 3 is a block diagram of a circuit constructed in accordance with an alternative embodiment of the invention.

### DETAILED DESCRIPTION OF THE INVENTION

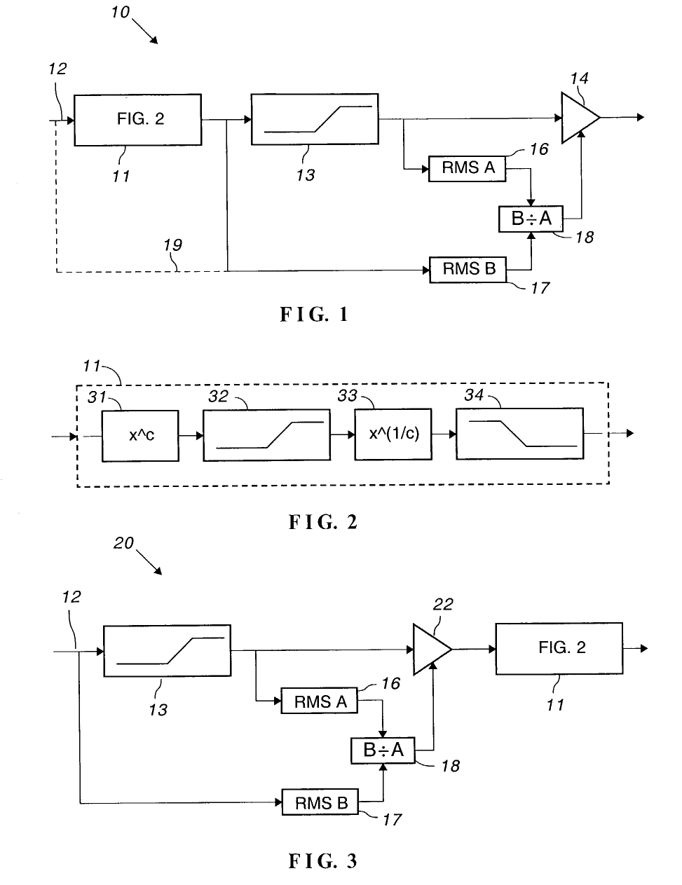

In FIG. 1, circuit 10 includes generator 11 for adding odd harmonics to a signal applied to input 12 to produce an enhanced signal. Generator 11 is described in greater detail in FIG. 2. The output from generator 11 is coupled to the input of high shelf filter 13. High shelf filter 13 differs from a high pass filter in that the response curve is flat above and below the cut-off frequency of the filter. For example, if filter 13 has a cut-off frequency of 800 Hz, frequencies below about 500 Hz are attenuated the same amount. Shelf filters are also known in the art as Baxandall filters. Filter 13 uniformly attenuates the low frequency components of the enhanced signal.

The output from filter 13 is multiplied by a factor determined by the ratio of high frequency components to low frequency components. Specifically, detector 16 determines the approximate RMS level of the signal at the output from filter 13 and detector 17 determines the approximate RMS level of the signal at the input of the filter. Detectors 16 and 17 compute RMS using techniques known in the art, such as the Taylor series. Other techniques can be used instead, e.g. exponential windowing, which approximate the result. Divider 18 computes the ratio of the RMS values and produces a control signal representative of (B÷A).

The control signal varies the gain of amplifier 14 in accordance with the ratio of the RMS values. More specifically, the control signal varies the gain of amplifier 14 proportional to the unfiltered or wideband signal and inversely proportional to the filtered signal. As indicated by dashed line 19, detector 17 can be coupled to the input of harmonics generator 11 instead of the output. This will slightly reduce the value of “B” at any instant because the harmonic content is lower. In either case, the output signal from amplifier 14 has substantially the same average energy as the signal on input 12.

In FIG. 2, harmonic generator 11 includes non-linear amplifier 31 coupled to high shelf filter 32. Amplifier 31 does not have a square law response but a response of x^{c}, where 1<c<2 and, preferably, 1.2≦c≦1.5. Such fractional powers are easily implemented digitally using techniques such as Taylor series. The input signal can have negative values. Therefore, the actual calculation is sgn(x)·[abs(x)]^{c}, which is read as the absolute value of x to the c power times the sign of x; thereby preserving the sign of the signal.

The expanded output signal from high shelf filter 32 is coupled through nonlinear amplifier 33 to low shelf filter 34. Amplifier 33 provides a fractional root, compressing the signal. (For the root, the sign of the signal is preserved. There is no real root for a negative number.) Filter 34 flattens the frequency response of harmonics generator 11. It has been found that the fractional power and fractional root combined with shelf filtering provide increased harmonic content without excessive distortion of the signal, such as caused by harmonic generators that use clipping.

Although other values can be used, high shelf filter 32 preferably has a cut-off frequency in the range of 800 Hz to 1,200, with 1,000 Hz being preferred. Low shelf filter 34 preferably has the same cut-off frequency as the high shelf filter and preferably has a cut-off frequency within the same range as the high shelf filter.

FIG. 3 is a block diagram of a circuit constructed in accordance with an alternative embodiment of the invention in which filtering occurs before harmonic generation. In the embodiment shown in circuit 20, input 12 is coupled to high shelf filter 13 and amplifier 22 is coupled to harmonic generator 11. The gain of amplifier 22 is adjusted as described above and the output signal from generator 11 may seem slightly louder than the unmodified signal at input 12 because of the added harmonic content.

The invention thus provides a circuit for improving the perception of speech in which the power level of the output signal is approximately the same as the power level of the input signal. The circuit can be configured to have no algorithm latency. The circuit is relatively simple, less expensive, and more effective than circuits of the prior art.

Having thus described the invention, it will be apparent to those of skill in the art that various modifications can be made within the scope of the invention. For example, the circuits shown may include other apparatus, such as buffer amplifiers or digital processing means, that is ancillary to the apparatus shown. Such ancillary apparatus does not include a clipper to create odd harmonics, for example, which would substantially change, and degrade, the signal. As noted above, methods other than Taylor series can be used for computing RMS values. More typical high pass. low pass, or band pass filters (filters with a continuous response curve) can be used instead of shelf filters, with some decrease in performance. The gain of amplifier 14 or 22 does not have to be a linear function of the ratio of the RMS values, although a linear function is preferred. While illustrated as a variable gain amplifier, elements 14 and 22 are multipliers when the circuit is implemented digitally.

What is claimed as the invention is:

1. An apparatus for processing an electrical signal representing speech for enhancing the perception of speech, said apparatus comprising:
a harmonics generator having an input for receiving said electrical signal and an output, said generator increasing the harmonic content of the electrical signal;
a first filter coupled to said output and producing a filtered output signal;
a multiplier coupled to said first filter for adjusting the amplitude of the filtered output signal;
a first amplitude detector coupled to said first filter for producing a first control signal representative of said filtered output signal;
a second amplitude detector coupled to said harmonics generator for producing a second control signal; and
a divider for producing a third control signal representative of the ratio of the second control signal to the first control signal;
wherein said third control signal is coupled to said multiplier for adjusting the amplitude of the filtered output signal.

2. The apparatus as set forth in claim 1 wherein said harmonics generator increases the odd harmonics of said electrical signal.

3. The apparatus as set forth in claim 1 wherein said second amplitude detector is coupled to the output of said harmonics generator.

4. The apparatus as set forth in claim 1 wherein said second amplitude detector is coupled to the input of said harmonics generator.

5. The apparatus as set forth in claim 1 wherein said harmonics generator includes:
a first amplifier having a first exponential transfer function;
a second filter coupled to said first amplifier; and
a second amplifier having a second exponential transfer function;
wherein said first exponential transfer function is a power greater than one and less than two and said second exponential transfer function is a power greater than zero and less than one.

6. The apparatus as set forth in claim 5 wherein said harmonics generator further includes a third filter coupled to said second amplifier.

7. The apparatus as set forth in claim 6 wherein said second filter is a high shelf filter and said third filter is a low shelf filter.

8. The apparatus as set forth in claim 5 wherein said first exponential transfer function is a power ≧1.2 and ≧1.5.

9. The apparatus as set forth in claim 1 wherein said first filter is a high shelf filter.

10. An apparatus for increasing the harmonic content of an electrical signal, said apparatus comprising:
a first amplifier having a first transfer function, sgn(x)·[abs(x)]^{c};
a first filter coupled to said first amplifier; and
a second amplifier having a second transfer function, sgn(x)·[abs(x)]^{1/c};
wherein 1<c<2.

11. The apparatus as set forth in claim 10 and further including:
a second filter coupled to said second amplifier.

12. The apparatus as set forth in claim 10 wherein 1.2≦c≦1.5.

13. A method for processing an electrical signal representing speech for enhancing the perception of speech, said method comprising the steps of:
increasing the harmonic content of the electrical signal to produce an enhanced signal;
attenuating low frequency components of the enhanced signal to produce a filtered, enhanced signal; and
adjusting the amplitude of the filtered, enhanced signal in accordance with the ratio of the amplitudes of the unfiltered signal to the filtered signal.

14. The method as set forth in claim 13 wherein said increasing step includes the step of increasing the odd harmonic content of the electrical signal.

15. The method as set forth in claim 13 wherein said increasing step includes the steps of:
expanding the electrical signal by a power less than two to produce an augmented signal;
attenuating low frequency components of the augmented signal to produce a filtered, augmented signal; and
compressing the filtered, augmented signal by a power greater than zero and less than one.

16. The method as set forth in claim 15 wherein said increasing step further includes the step of:
attenuating high frequency components of the filtered, augmented signal to produce the enhanced signal.

17. A method for processing an electrical signal representing speech for enhancing the perception of speech, said method comprising the steps of:
attenuating low frequency components of the electrical signal to produce an enhanced signal; and
adjusting the amplitude of the enhanced signal in accordance with the ratio of the amplitudes of the electrical signal to the enhanced signal.

18. The method as set forth in claim 17 and further including the step of:
increasing the odd harmonic content of the enhanced signal to produce an output signal.

19. The method as set forth in claim 18 wherein said increasing step is the first step in the method.

20. The method as set forth in claim 18 wherein said increasing step is the last step in the method.

21. The method as set forth in claim 17 wherein said increasing step includes the steps of:
expanding the enhanced signal by a power less than two to produce an augmented signal;
attenuating low frequency components of the augmented signal to produce a filtered, augmented signal; and
compressing the filtered, augmented signal by a power greater than zero and less than one; and
attenuating high frequency components of the filtered, augmented signal to produce the output signal.
